(19) United States
(12) Patent Application Publication
(10) Pub. No.: US 2008/0020201 A1
(43) Pub. Date: Jan. 24, 2008

(54) Composite, Color Corrected Films Comprising an Aluminum Oxide Coating

(76) Inventors: Lisa Yvonne Winckler, Collinsville, VA (US); Charles Nicholas Van Nutt, Martinsville, VA (US); Janos Czukor, Martinsville, VA (US)

Correspondence Address: BRENC LAW;ANDREW BRENC, P.O. BOX 155, ALBION, PA, 16401-0155, US

(21) Appl. No.: 11/780,443

(22) Filed: Jul. 19, 2007

Related U.S. Application Data
(60) Provisional application No. 60/826,261, filed on Sep. 20, 2006.
(60) Provisional application No. 60/807,873, filed on Jul. 20, 2006.

(51) Int. Cl. B32B 15/00

(52) U.S. Cl. 428/336; 428/469; 428/688

(57) ABSTRACT

Now, according to the present invention, composite solar control films are provided that are effective at controlling solar radiation while also presenting an appealing coloration. Composite solar control films of the present invention comprise two or more polymer films bonded together, wherein at least one of the polymer film layers comprises a layer of non-stoichiometric aluminum oxide.

### CROSS-REFERENCE TO RELATED APPLICATIONS

This application claims priority to U.S. Provisional Applications 60/826,261, filed on Sep. 20, 2006, and 60/807,873, filed on Jul. 20, 2006, each of which is hereby incorporated by reference in its entirety.

### FIELD OF THE INVENTION

The present invention is in the field of solar control films, and, specifically, the present invention is in the field of solar control films that are used in vehicle and architectural applications to reduce heat buildup in an enclosed space.

### BACKGROUND

Polymeric, transparent performance films that can be disposed directly on the surface of glass have been used to reduce the amount of electromagnetic radiation of various wavelengths passing through the glass. Performance films typically comprise a polymer film substrate onto which one or more layers of metals and/or dielectric materials have been applied. The applied layers function to absorb and/or reflect a subset of wavelengths of electromagnetic radiation, where the wavelength is determined by the thicknesses and optical properties of the applied layers.

One broad application of this technology involves using a coated film to reduce the amount of solar radiation that passes through an opening into an enclosed space. In a typical embodiment, these solar control films are applied to the window of an automobile or other vehicle in order to reduce the amount of solar radiation that enters the vehicle. Performance films of this type are designed, or “tuned”, to absorb and/or reflect an acceptably low percentage of the visible solar spectrum while still preventing the transmission of enough total solar radiation to appreciably reduce the heat gain inside a vehicle caused by exposure to solar radiation.

Conventional solar control films, however, often are a compromise between function and appearance; while a film may be well suited to perform its solar control function, for example, its appearance may be less than desirable. Solar control polymer films, depending on the materials used, can have a particular color that, if not corrected, results in a finished film that is aesthetically unappealing.

Correction techniques include, for example, using a dyed film base or pigments to change the optical properties of the film, thereby correcting any deficiency inherent in the solar control metal layer. Another correction technique involves bonding a second film to the solar control film wherein the second film has one or more dyes, pigments, or other color correction agents to produce a composite solar control film having a desirable finished appearance. These color correction techniques, however, each have one or more limitations.

There is a need in the art for solar control films that stably provide the desired solar control while also providing an appealing tint.

### SUMMARY OF THE INVENTION

Now, according to the present invention, composite solar control films are provided that are effective at controlling solar radiation while also presenting an appealing coloration. Composite solar control films of the present invention comprise two or more polymer films bonded together, wherein at least one of the polymer film layers comprises a layer of non-stoichiometric aluminum oxide.

### DETAILED DESCRIPTION

Composite solar control films of the present invention comprise two or more polymer film layers, with a layer of non-stoichiometric aluminum oxide deposited on one of the two films. As will be described in detail below, the polymer films can comprise any suitable polymeric material, and, in a preferred embodiment, one or more of the polymer films comprises poly(ethylene terephthalate).

At least one of the polymer films of the composites of the present invention has an aluminum oxide layer that is formed in a manner that results in a non-stoichiometric layer of aluminum oxide.

As used herein, “non-stoichiometric” aluminum oxide means aluminum oxide in which the atomic ratio of oxygen to aluminum is less than 3 to 2. Fully oxidized aluminum is commonly known as Al₂O₃. Aluminum metal, by nature, when exposed to the atmosphere, gets covered with a “native” oxide layer. This native oxide layer is fully oxidized and prevents the further oxidization of the rest of the metal underneath when it has reached to about three nanometers thickness. For the purposes of the present invention, the term “non-stoichiometric” aluminum oxide refers only to the aluminum oxide under the native oxide layer, and so a “layer of non-stoichiometric aluminum oxide” comprises, in addition to an underlying non-stoichiometric portion, a very thin, overlying portion that is fully oxidized aluminum oxide. Ratios of oxygen and aluminum provided herein for “non-stoichiometric” aluminum oxide refer only to the underlying portion of non-stoichiometric aluminum oxide, and not to the very thin native oxide layer that becomes oxidized during or immediately after fabrication of the aluminum oxide layer.

In further embodiments of the present invention, the atomic ratio of oxygen to aluminum in non-stoichiometric aluminum oxide of the present invention is less than 2.55 to 2, less than 3 to 4, or less than 1 to 2. For any of these embodiments, as well as the embodiments with an atomic ratio of less than 3 to 2, the lower limit of the atomic ratio can be greater than 1 to 50.

The non-stoichiometric aluminum oxide layer can be formed in any suitable thickness, and, in preferred embodiments, the layer has a thickness of 3.5 to 50 nanometers, 3.5 to 40 nanometers, or 3.5 to 30 nanometers.

In various embodiments of the present invention, a film having a non-stoichiometric layer of aluminum oxide has the following light transmission properties: Visible Light Transmission: 5 to 80%; Solar Absorptance: 5 to 70%; and Total Solar Energy Rejection: 5 to 60%, or Visible Light Transmission: 40 to 60%; Solar Absorptance: 30 to 50%; and Total Solar Energy Rejection: 30 to 50%.

In combination with a second polymer film, in various embodiments, a film having a non-stoichiometric layer of aluminum oxide has the following light transmission properties: Visible Light Transmission: 2 to 65%; Solar Absorptance: 10 to 80%; and Total Solar Energy Rejection: 20 to 80%, or Visible Light Transmission: 30 to 50%; Solar Absorptance: 35 to 55%; and Total Solar Energy Rejection: 56 to 76%.

Formation of a non-stoichiometric layer of aluminum oxide can be accomplished using conventional vacuum deposition techniques such as sputtering or evaporation of aluminum in an atmosphere that comprises an oxidizing gas and optionally an inert gas, such as argon. By controlling the amount of oxygen in the vacuum deposition atmosphere, the aluminum to oxygen ratio can be adjusted to produce the desired non-stoichiometric aluminum oxide layer.

In other embodiments, non-stoichiometric aluminum oxide can be provided as the target in a sputtering process or as the evaporative material in an evaporation process in a atmosphere substantially lacking an oxidizing gas. In these processes, the final oxygen to aluminum ratio of the non-stoichiometric layer of aluminum oxide will be determined by the ratio found in the starting material.

As an alternative to vacuum deposition, a nano particulate solution or suspension of aluminum oxide can be prepared and spread on a film layer to form the non-stoichiometric aluminum oxide layer.

Composite films of the present invention are formed by bonding the above-described polymer film having a layer of non-stoichiometric aluminum oxide to a second polymer film. The second polymer film can comprise the same or different material, and can, optionally, have a second non-stoichiometric aluminum oxide layer disposed on its surface.

The second polymer film has a hue that, when bonded with the polymer film having a layer of non-stoichiometric aluminum oxide, results in a composite film with a hue that is different from the hue of the second polymer film alone. This result is termed “color correction”.

The two films can be bonded to each other so that the non-stoichiometric aluminum oxide layer is either between the two layers or on one of the outside surfaces of the composite film.

The first polymer film with a layer of non-stoichiometric aluminum oxide can be dyed or otherwise colored. The second polymer film can be dyed, can comprise pigments, can have one or more layers of metals, metal oxides, ceramics, or can have a combination of the foregoing.

The composite films of the present invention can comprise more than two layers of polymer film, and, in various embodiments, composite films can comprise 1, 2, or 3 or more layers of bonded polymer films in addition to the two layers described above.

Polymer film layers of the present invention can be bonded together with any suitable bonding material.

Composite polymer films of the present invention that comprise a layer of non-stoichiometric aluminum oxide can be adhered to any suitable glazing substrate using any suitable adhesive. In various embodiments of the present invention, a composite film is adhered to a window or windshield of a vehicle. In other embodiments, a composite film is adhered to architectural glass, such as a window. In either case, a glass composite is formed that comprises glass or a glass laminate and a composite film of the present invention comprising a layer of non-stoichiometric aluminum oxide.

For these applications, adhesives such as a pressure sensitive adhesive, for example silicone or acrylic, that is a removable adhesive or a permanent adhesive, can be formed to completely cover the composite film or only a sub-portion thereof. Adhesives can be applied to the composite film, or they can be sprayed on or otherwise applied to the glass onto which the composite film is applied. Applications such as these can be retrofit applications or new glass applications.

Adhesive layers of the present invention, such as an adhesive bonding two polymer films together, can have a negligible thickness, for example less than 0.10 millimeters in thickness, less than 0.06 millimeters in thickness, or 0.002 to 0.06 millimeters in thickness. Adhesive layers can comprise any suitable adhesive, as is known in the art and as described elsewhere herein for adhering composite films to glass.

In various embodiments of the present invention, a polymer film includes a porous primer layer, such as a silicon oxide layer, onto which other layers can be deposited. Porous primer layers include those described in issued U.S. Pat. No. 6,123,986.

In various embodiments of the present invention, a layer of nickel or nickel alloy is included between the polymer film and the layer of non-stoichiometric aluminum oxide. A porous primer layer can be included on the polymer film. The nickel or nickel alloy layer can be applied using any suitable means, such as sputtering, and can be any suitable thickness. In preferred embodiments, the nickel or nickel alloy layer is 0.50 to 5.0 nanometers, 1.0 to 3.0 nanometers, or 1.50 to 2.35 nanometers. In a preferred embodiment, a nickel alloy is used having the following composition, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance as Ni.

In various embodiments, other suitable metals other than nickel and nickel alloys can be employed as described in the preceding paragraph. In various embodiments, Al, Ti, Ag, Au, Cu, Sn, Zn, Ni, and the like, and/or their alloys are used. In various embodiments, aluminum or titanium is used.

In various embodiments, solar control glass (solar glass) is used as a glass layer of the present invention. Solar glass can be any conventional glass that incorporates one or more additives to improve the optical qualities of the glass, and specifically, solar glass will typically be formulated to reduce or eliminate the transmission of undesirable wavelengths of radiation, such as near infrared and ultraviolet. Solar glass can also be tinted, which results in, for some applications, a desirable reduction of transmission of visible light. Examples of solar glass that are useful in the present invention are bronze glass, gray glass, low E (low emissivity) glass, and solar glass panels as are known in the art, including those disclosed in U.S. Pat. Nos. 6,737,159 and 6,620,872.

In addition to the embodiments given above, other embodiments comprise a rigid glazing substrate other than glass. In these embodiments, the rigid substrate can comprise acrylic such as Plexiglas®, polycarbonate such as Lexan®, and other plastics, that are conventionally used as glazings.

### Polymer Film

The polymer film can be any suitable thermoplastic film that is used in glazing film manufacture. In various embodiments, the thermoplastic film can comprise polycarbonates, acrylics, nylons, polyesters, polyurethanes, polyolefins such as polypropylene, cellulose acetates and triacetates, vinyl acetals, such as poly(vinyl butyral), vinyl chloride polymers and copolymers and the like, or another plastic suitable for use in a performance film.

In various embodiments, the polymer film is a polyester film, for example poly(ethylene terephthalate). In various embodiments the polymer film can have a thickness of 0.012 millimeters to 0.40 millimeters, preferably 0.01 millimeters to 0.3 millimeters, or 0.02 to 0.025 millimeters. The polymer film can include, where appropriate, a primer layer to facilitate bonding of the non-stoichiometric aluminum oxide layer to the polymeric substrate, to provide strength to the substrate, and/or to improve the planarity.

The polymer films are optically transparent (i.e. objects adjacent one side of the layer can be comfortably seen by the eye of a particular observer looking through the layer from the other side). In various embodiments, the glazing film substrate comprises materials such as re-stretched thermoplastic films having the noted properties, which include polyesters. In various embodiments, poly(ethylene terephthalate) is used, and, in various embodiments, the poly(ethylene terephthalate) has been biaxially stretched to improve strength, and has been heat stabilized to provide low shrinkage characteristics when subjected to elevated temperatures (e.g. less than 2% shrinkage in both directions after 30 minutes at 150° C.).

Various coating and surface treatment techniques for poly(ethylene terephthalate) film that can be used with the present invention are disclosed in published European Application No. 0157030. Films of the present invention can also include an antifog layer, as are known in the art.

Useful example of polymer films that can be used with the present invention include those described in U.S. Pat. Nos. 6,049,419 and 6,451,414, and U.S. Pat. Nos. 6,830,713, 6,827,886, 6,808,658, 6,783,349, and 6,569,515.

In various embodiments of the present invention, a polymer film includes a primer layer that promotes adhesion of the non-stoichiometric aluminum oxide layer to the polymeric material.

In various embodiments of the present invention, a polymer film is dyed to impart color. Dyed polymer films are available, for example and without limitation, from CPFilms (Martinsville, Va.) in visible transmission ranges of 2 to 90%.

As used herein, a “clear weatherable film” is a polyester film that incorporates ultraviolet light absorbers.

### Hardcoats

In various embodiments, polymer films of the present invention comprise a hardcoat. A hardcoat can be formed over the layer of non-stoichiometric aluminum oxide to protect that layer from mechanical damage or deterioration caused by exposure to the environment, if, for example, the layer of non-stoichiometric aluminum oxide is formed on the outside, exposed surface of a two polymer film composite.

Any suitable, conventional hardcoat can be used as a scratch resistant layer on a polymer film of the present invention. In particular, the hardcoats may be a combination of poly(silicic acid) and copolymers of fluorinated monomers, with compounds containing primary alcohols (as described in U.S. Pat. No. 3,429,845), or with compounds containing primary or secondary alcohols (as described in U.S. Pat. No. 3,429,846). Other abrasion resistant coating materials suitable for the purpose are described in U.S. Pat. Nos. 3,390,203; 3,514,425; and, 3,546,318.

Further examples of useful hardcoats include cured products resulting from heat or plasma treatment of a hydrolysis and condensation product of methyltriethoxysilane.

Hardcoats that are useful also include acrylate functional groups, such as a polyester, polyether, acrylic, epoxy, urethane, alkyd, spiroacetal, polybutadiene or polythiol polyene resin having a relatively low molecular weight; a (meth)acrylate oligomer or prepolymer of a polyfunctional compound such as a polyhydric alcohol; or a resin containing, as a reactive diluent, a relatively large amount of a monofunctional monomer such as ethyl(meth)acrylate, ethylhexyl(meth)acrylate, styrene, methylstyrene or N-vinylpyrrolidone, or a polyfunctional monomer such as trimethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate or neopentyl glycol di(meth)acrylate.

In various embodiments, acrylate hard coats are preferred, and particularly urethane acrylates.

The present invention includes glazings having a composite film of the present invention disposed on a surface. In various embodiments, a glass layer, such as a window or a windshield, has a composite film of the present invention adhered on its surface to form a composite glass of the present invention.

The present invention includes safety bilayer glass panels, which are generally constructed with the following layer organization: glass layer//polymer sheet//composite polymer film. In these bilayer glass panels, the polymer sheet can be any suitable thermoplastic material, and, in various embodiments, the polymer sheet comprises plasticized poly(vinyl butyral)(PVB). In this bilayer embodiment, the composite polymer film can be any of the polymer films described herein comprising a layer of non-stoichiometric aluminum oxide. The bilayer can be formed using any conventional technique, including using a second, temporary pane of glass disposed in contact with the functional coating to allow for lamination of the bilayer, with subsequent removal of the temporary pane of glass after the lamination process bonds the other layers together into the bilayer.

Composite films of the present invention can be used as security and privacy devices. Because composite films of the present invention can be formulated to have low visible transmittance and high IR transparency, composite films can be used in applications to obscure visual inspection of text or printing, for example a bar code, unless a laser light reader is used, for example, to read reflected light in the near infrared range of 850-1100 nanometers.

The present invention provides an inexpensive and facile method for providing color-corrected films for use in automobile and architectural applications.

### EXAMPLES

### Example 1

A first film (Film 1) is prepared by sputtering metal onto a poly(ethylene terephthalate) film.

A second film (Film 2) is prepared by sputtering a layer of non-stoichiometric aluminum oxide onto a poly(ethylene terephthalate) weatherable film. The two films are bonded together using laminating adhesive 76R36B from Rohm & Haas Company (Philadelphia, Pa.) to produce a composite film. Light transmission, reflection, and absorbance characteristics are measured using a Cary UV, Visible, and NIR spectrometer model 5000. Results are shown in Table 1, where “Film 1” is the sputtered metal film, “Film 2” is the non-stoichiometric aluminum oxide film, “Bonded” is the composite film, and where “L*”, “a*”, and “b*” are references to the well-known “CIE L*a*b*” color space system.

TABLE 1

| Property | Film 1 | Film 2 | Bonded |
|---|---|---|---|
| % Solar Transmission | 34.20 | 48.80 | 20.70 |
| % Solar Reflection/Front Surface | 31.10 | 8.60 | 33.00 |
| % Solar Reflection/Back Surface | 33.10 | 12.50 | 22.00 |
| % Solar Absorptance | 34.70 | 42.50 | 46.30 |
| % Visible Light Transmission | 67.50 | 53.10 | 40.20 |
| % Visible Light Reflectance/Front Surface | 11.00 | 8.90 | 10.50 |
| % Visible Light Reflectance/Back Surface | 9.30 | 14.10 | 14.40 |
| Solar Heat Gain Coefficient | 43.90 | 51.00 | 33.80 |
| Shading Coefficient | 51.00 | 71.00 | 39.00 |
| % Total Solar Energy Rejection | 56.10 | 39.00 | 66.20 |
| % Transmission L* | 85.64 | 77.91 | 69.51 |
| % Transmission a* | −3.87 | −0.98 | −2.96 |
| % Transmission b* | 4.52 | 1.78 | 3.94 |
| % Front Reflection L* | 39.81 | 35.77 | 39.02 |
| % Front Reflection a* | −6.74 | −0.6 | −4.87 |
| % Front Reflection b* | −2.37 | 0.31 | −4.01 |
| % Back Reflection L* | 36.76 | 44.49 | 44.90 |
| % Back Reflection a* | −1.26 | −0.42 | −0.97 |
| % Back Reflection b* | −4.89 | −2.03 | −1.77 |

Although embodiments of the present invention have been described herein, it will be clear to those of ordinary skill in the art that many other permutations are possible and are within the scope and spirit of the present invention. In addition, many modifications may be made to adapt a particular situation or material to the teachings of the invention without departing from the essential scope thereof. Therefore, it is intended that the invention not be limited to the particular embodiments disclosed herein for carrying out this invention, but that the invention will include all embodiments falling within the scope of the appended claims.

It will further be understood that any of the ranges, values, or characteristics given for any single component of the present invention can be used interchangeably with any ranges, values, or characteristics given for any of the other components of the invention, where compatible, to form an embodiment having defined values for each of the components, as given herein throughout.

Any figure reference numbers given within the abstract or any claims are for illustrative purposes only and should not be construed to limit the claimed invention to any one particular embodiment shown in any figure.

Unless otherwise noted, drawings are not drawn to scale.

Each reference, including journal articles, patents, applications, and books, referred to herein is hereby incorporated by reference in its entirety.

We claim:

1. A composite glazing film, comprising:
a first polymer film;
an optional primer layer;
an optional layer of metal or metal alloy;
a layer of non-stoichiometric aluminum oxide;
an adhesive layer disposed on said layer of non-stoichiometric aluminum oxide or on said first polymer film opposite said layer of non-stoichiometric aluminum oxide; and,
a second polymer film disposed in contact with said adhesive layer.

2. The composite glazing film of claim 1, wherein said second polymer film is a dyed film, a sputtered film, or a clear weatherable film.

3. The composite glazing film of claim 1, wherein said layer of non-stoichiometric aluminum oxide has an oxygen to aluminum atomic ratio of less than 3 to 2.

4. The composite glazing film of claim 1, wherein said layer of non-stoichiometric aluminum oxide has an oxygen to aluminum atomic ratio of less than 2.55 to 2.

5. The composite glazing film of claim 1, wherein said layer of non-stoichiometric aluminum oxide has a thickness of 3.5 to 50 nanometers.

6. The composite glazing film of claim 1, wherein said layer of non-stoichiometric aluminum oxide has a thickness of 3.5 to 40 nanometers.

7. The composite glazing film of claim 1, wherein said layer of non-stoichiometric aluminum oxide has the following optical transmission properties: visible light transmission: 30 to 50%; solar absorptance: 35 to 55%; and total solar energy rejection: 56 to 76%.

8. The composite glazing film of claim 1, wherein said layer of metal or metal alloy comprises nickel or nickel alloy.

9. The composite glazing film of claim 8, wherein said nickel or nickel alloy layer has a thickness of 0.50 to 5.0 nanometers.

10. The composite glazing film of claim 9, wherein said nickel or nickel alloy layer comprises the following elements, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance Ni.

11. A glass composite comprising:
a layer of glass;
an adhesive layer;
a composite glazing film, comprising;
a first polymer film;
an optional primer layer;
an optional layer of metal or metal alloy;
a layer of non-stoichiometric aluminum oxide;
an adhesive layer disposed either on said layer of non-stoichiometric aluminum oxide or on said first polymer film opposite said layer of non-stoichiometric aluminum oxide; and,
a second polymer film disposed in contact with said adhesive layer.

12. The glass composite of claim 11, wherein said layer of non-stoichiometric aluminum oxide has an oxygen to aluminum atomic ratio of less than 3 to 2.

13. The glass composite of claim 11, wherein said layer of non-stoichiometric aluminum oxide has an oxygen to aluminum atomic ratio of less than 2.55 to 2.

14. The glass composite of claim 11, wherein said layer of non-stoichiometric aluminum oxide has a thickness of 3.5 to 50 nanometers.

15. The glass composite of claim 11, wherein said layer of non-stoichiometric aluminum oxide has a thickness of 3.5 to 40 nanometers.

16. The glass composite of claim 11, wherein said non-stoichiometric aluminum oxide layer has the following optical transmission properties: visible light transmission: 30 to 50%; solar absorptance: 35 to 55%; and total solar energy rejection: 56 to 76%.

17. The glass composite of claim 11, wherein said layer of metal or metal alloy comprises nickel or nickel alloy.

18. The glazing film of claim 17, wherein said nickel or nickel alloy layer has a thickness of 0.50 to 5.0 nanometers.

19. The glass composite of claim 18, wherein said nickel or nickel alloy layer comprises the following elements, with each element given as a maximum percent by weight: C 0.004, Fe 5.31, Mo 15.42, Mn 0.48, Co 1.70, Cr 15.40, Si 0.02, S 0.004, P 0.005, W 3.39, V 0.16, and the balance Ni.

20. The glass composite of claim 11, wherein one of said second polymer film is a dyed film, a sputtered film, or a clear weatherable film.
